(19) United States
(12) Patent Application Publication
(10) Pub. No.: US 2010/0203352 A1
(43) Pub. Date: Aug. 12, 2010

(54) FOIL LAMINATE ADHESIVE TAPE

(75) Inventors: Michael E. Hill, Franklin, KY (US); George G. Puckett, Ruston, LA (US); Jeffrey S. Coats, Nashville, TN (US)

Correspondence Address: BARNES & THORNBURG LLP, 11 SOUTH MERIDIAN, INDIANAPOLIS, IN, 46204, US

(73) Assignee: BERRY PLASTICS CORPORATION, Evansville, IN (US)

(21) Appl. No.: 12/634,138

(22) Filed: Dec. 9, 2009

Related U.S. Application Data
(60) Provisional application No. 61/121,446, filed on Dec. 10, 2008.

(51) Int. Cl. B32B 15/04; B32B 7/10

(52) U.S. Cl. 428/623

(57) ABSTRACT

An adhesive tape includes a backing material and an adhesive material coupled to the backing material. A release liner is coupled to an exposed portion of the adhesive material.

This application claims priority under 35 U.S.C. §119(e) to U.S. Provisional Application Ser. No. 61/121,446, filed Dec. 10, 2008, which is expressly incorporated by reference herein.

### BACKGROUND

The present disclosure relates to adhesive tape, and particularly to laminate adhesive tape. More particularly, the present disclosure relates to a foil-backed laminate tape.

### SUMMARY

An adhesive tape in accordance with the present disclosure includes a backing sheet and an adhesive sheet. In illustrative embodiments, a release liner is coupled to the adhesive sheet. The adhesive sheet is arranged to couple the backing sheet to an article after removal of the release liner from the adhesive sheet.

In illustrative embodiments, the backing sheet is defined by a three-ply laminated sheet that includes a first foil layer, a non-foil substrate layer, and a second foil layer. The first foil layer is coupled to a first side of the substrate layer and the second foil layer is coupled to an opposite second side of the substrate layer. In illustrative embodiments, each of the first and second foil layers is made of an aluminum alloy and there is no aluminum in the non-foil substrate layer.

In illustrative embodiments, the substrate layer comprises a first binder stratum, a core stratum, and a second binder stratum. The first binder stratum is arranged to lie between the core stratum and the first foil layer. The second binder stratum is arranged to lie between the core stratum and the second foil layer. In one embodiment, the core stratum is made of a non-woven polymeric material such as polyester or polypropylene. In another embodiment, the core stratum is made of a non-polymeric material such as paper. In illustrative embodiments, each of the first and second foil layers is made of a polyethylene or a polypropylene material.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a diagrammatic view of a first embodiment of a foil laminate adhesive tape made in accordance with the present disclosure showing that the foil laminate adhesive tape includes a three-ply laminated layer including a first foil layer, a substrate layer comprising a binder stratum, and a second foil layer, an adhesive sheet, and a release liner;

FIG. 2 is a diagrammatic view of a foil laminate adhesive tape in accordance with a second embodiment of the present disclosure showing that the substrate layer comprises a first binder stratum, a polymer stratum, and a second-binder stratum;

FIG. 3 is a diagrammatic view of a foil laminate adhesive tape in accordance with a third embodiment of the present disclosure showing that the substrate layer comprises a first binder stratum, a paper stratum, and a second binder stratum; and

FIG. 4 is a diagrammatic view of a foil laminate adhesive tape in accordance with a fourth embodiment of the present disclosure showing that an illustrative substrate layer in combination with a particular adhesive sheet which does not require the use of a release liner.

### DETAILED DESCRIPTION

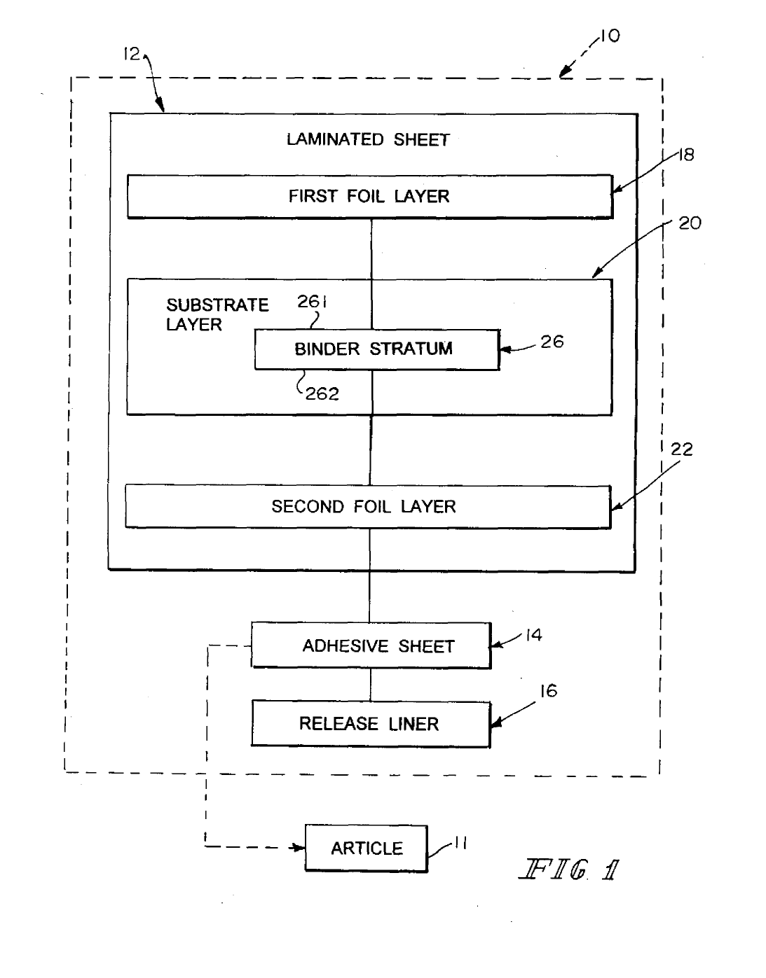

In accordance with the present disclosure, a pressure-sensitive tape comprises an adhesive sheet coupled to a three-ply laminated sheet comprising a non-foil substrate layer interposed between and coupled to first and second foil layers. In illustrative embodiments, the substrate layer comprises a non-woven material such as polyester or polypropylene. In illustrative embodiments, a release liner is mated to the adhesive sheet to locate the adhesive sheet between the three-ply laminated sheet and the release liner. The adhesive sheet is mated to the second foil layer and the release liner. Several embodiments of a pressure-sensitive tape in accordance with the present disclosure are shown diagrammatically in FIGS. 1-4.

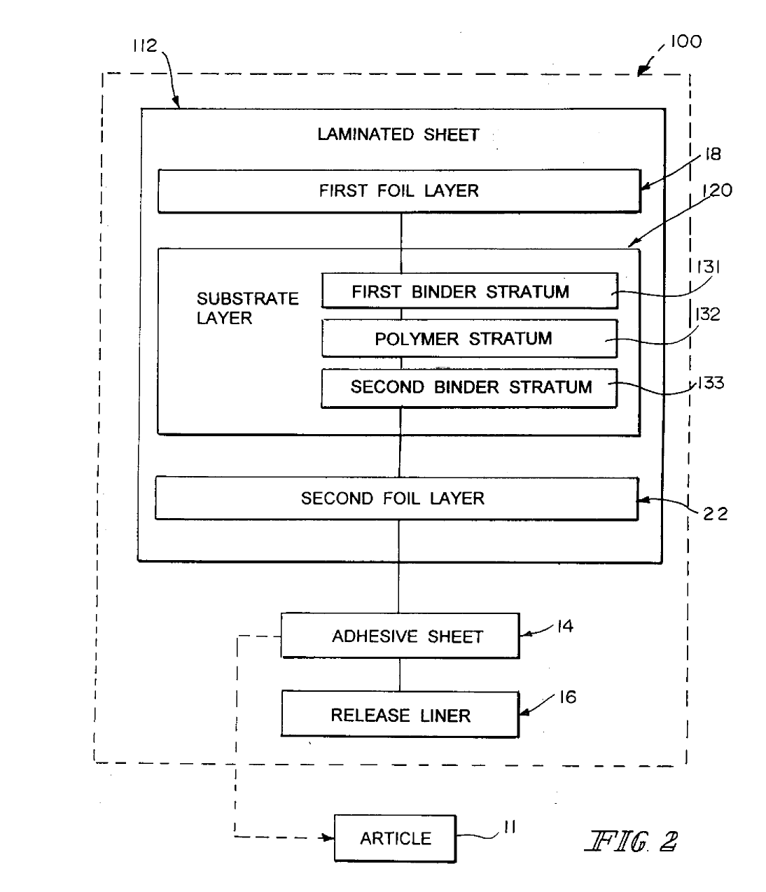

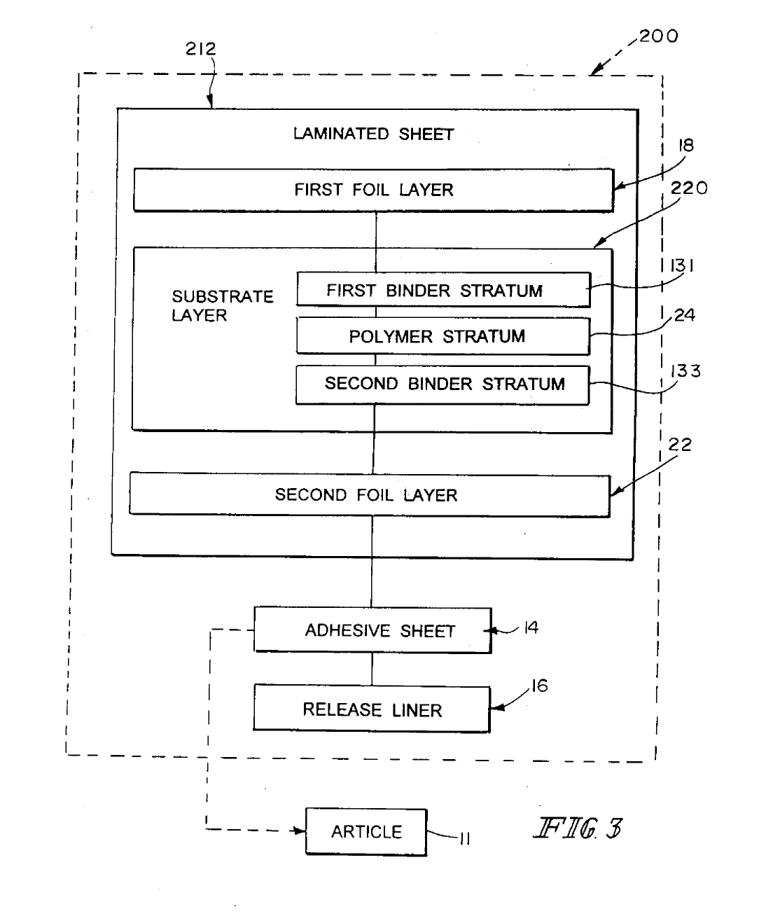

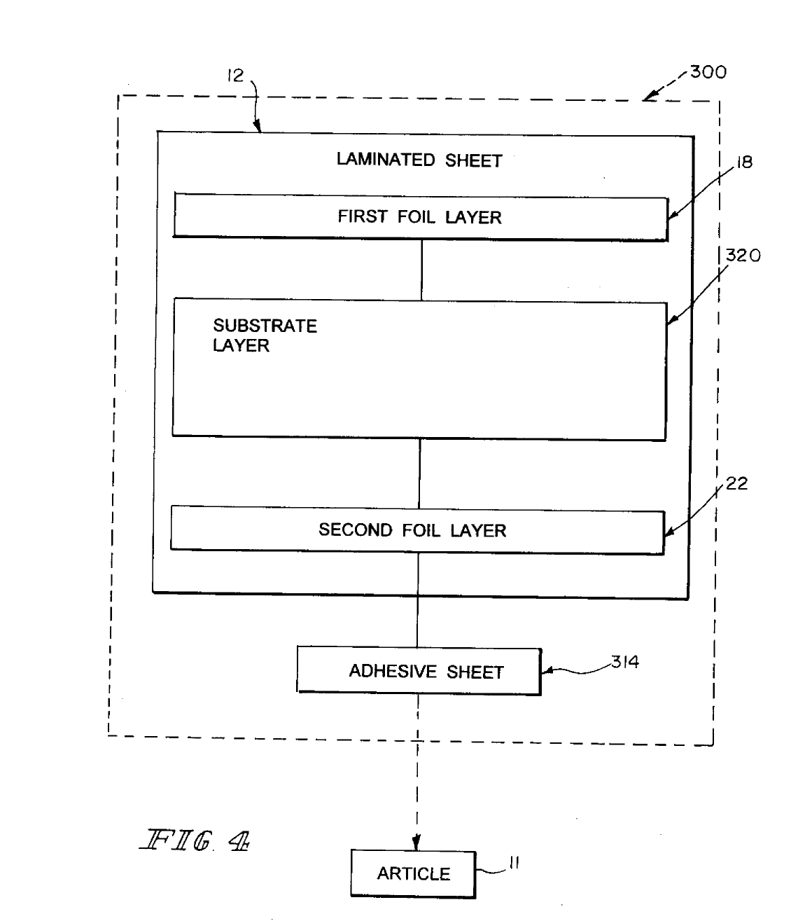

A first embodiment of an adhesive tape 10 is shown in FIG. 1. A second embodiment of an adhesive tape 100 is illustrated in FIG. 2 while a third embodiment of an adhesive tape 200 is shown in FIG. 3. Adhesive tapes 10, 100, 200 are differentiated by the components included in substrate layers 20, 120, 220 of laminated sheets 12, 112, 212. A fourth embodiment of an adhesive tape 300 is shown in FIG. 4. Adhesive tape 300 illustratively includes substrate layer 20, but uses other substrate layers 120, 220 in combination with an adhesive sheet 314 which does not require the use of release liner 16.

An adhesive tape 10 in accordance with a first embodiment of the present disclosure comprises a three-ply laminated sheet 12, an adhesive sheet 14, and a release liner 16 as indicated in FIG. 1. Adhesive sheet 14 is positioned to lie between release liner 16 and three-ply laminated sheet 12 so that adhesive sheet 14 interconnects three-ply laminated sheet 12 and release liner 16. Release liner 16 is configured to be removed from adhesive sheet 14 prior to application of adhesive tape 10 to an article 11 such as an air duct.

Three-ply laminated sheet 12 comprises a first foil layer 18, a substrate layer 20, and a second foil layer 22 as shown in FIG. 1. Substrate layer 20 is positioned to lie between first foil layer 18 and second foil layer 22 and to interconnect first foil and second foil layers 18, 22. Adhesive sheet 14 is positioned to lie between second foil layer 22 and release liner 16 and is configured to remain coupled to second foil layer 22 during removal of release liner 16 from adhesive sheet 14.

As shown in FIG. 1, substrate layer 20 illustratively is a single binder stratum 26. Binder stratum 26 is coupled on a first side 261 thereof to first foil layer 18 and is coupled on an opposite second side 262 thereof to second foil layer 22. Binder stratum 26 functions to provide means for bonding first foil layer 18 to second foil layer 22 and providing increased thickness to the resulting foil laminate layer 12. In an illustrative embodiment, single binder stratum 26 is made of a low-density polyethylene (LDPE) and has a thickness of about 1.0 mil.

An adhesive tape 100 in accordance with a second embodiment of the present disclosure is shown in FIG. 2. Adhesive tape 100 comprises a three-ply laminated sheet 112, an adhesive sheet 14, and a release liner 16. Three-ply laminated sheet 112 comprises a first foil layer 18, a substrate layer 120, and a second foil layer 22.

Substrate layer 120 comprises a first binder stratum 131, a core stratum such as a polymer stratum 132, and a second binder stratum 133 as suggested in FIG. 2. First binder stratum 131 is positioned to lie between and to interconnect polymer stratum 132 and first foil layer 18. Second binder stratum 133 is positioned to lie between and to interconnect polymer stratum 132 and second foil layer 22. In illustrative embodiments, polymer stratum 132 includes a non-woven material such as polyester or polypropylene.

An adhesive tape 200 in accordance with a third embodiment of the present disclosure comprises a three-ply laminated sheet 212, an adhesive sheet 14, and a release liner 16. Foil laminate layer 212 comprises a first foil layer 18, a substrate layer 220, and a second foil layer 22.

As suggested in FIG. 3, substrate layer 220 comprises a first binder stratum 131, a core stratum such as a paper stratum 24, and a second binder stratum 133. First binder stratum 131 is positioned to lie between and to interconnect paper stratum 24 and first foil layer. Second binder stratum 133 is positioned to lie between and to interconnect paper stratum 24 and second foil layer 22.

An adhesive tape 300 in accordance with a fourth embodiment of the present disclosure comprises a three-ply laminated sheet 12 and an adhesive sheet 314 applied to one side of three-ply laminated sheet 12 as suggested in FIG. 4. Three-ply laminated sheet 12 comprises a first foil layer 18, a substrate layer 320, and a second foil layer 22. Substrate layer 320 is defined either by substrate layer 20 or substrate layer 120 or substrate layer 220 in accordance with the present disclosure. In an illustrative embodiment, adhesive sheet 314 is a heat-activated adhesive that does not require release liner 16.

In illustrative embodiments, first foil layer 18 is, for example, a metallic sheet made of an aluminum alloy and is formed to have a thickness of about 0.5 mil. Second foil layer 22, for example, is a metallic sheet made of an aluminum alloy and is formed to have a thickness of about 0.285 mil.

Each of substrate layers 20, 120, 220 is configured to provide means for reducing the amount of aluminum alloy required to manufacture adhesive tapes 10, 100, 200, 300, thereby resulting in reduced manufacturing costs. In an illustrative embodiment, binder stratum 26 included in substrate layer 20, is made of a polyethylene material formed to have a thickness of about 1.0 mil. In another illustrative embodiment, binder stratum 26 is made of a polypropylene material. Three-ply laminated sheet 12 is formed to have an overall thickness of about 1.5 mil to about 3.0 mil in illustrative embodiments.

Substrate layer 120 comprises first binder stratum 131, polymer stratum 132, and second binder stratum 133. In illustrative embodiments, first and second binder stratums 131, 133 are made of a polyethylene material, but may be of a polypropylene material or any suitable alternative. Polymer stratum 132, for example, is made of a non-woven material such as polyester or polypropylene. Polymer stratum 132 is used to increase the strength of the resulting adhesive tape 100, while allowing laminated sheet 112 to retain a thickness in the range of about 1.5 mil to about 3.0 mil.

Substrate layer 220 includes first binder stratum 131, paper stratum 24, and second binder stratum 133. In illustrative embodiments, paper stratum 24 is made from virgin 20-point paper but may be any suitable alternative. Three-ply laminated sheet 212 includes paper stratum 24 so as to provide three-ply laminated sheet 112 with an overall thickness of about 5.0 mil to about 6.0 in an illustrative embodiment. Paper stratum 24 is used to achieve the greater thickness because paper illustratively is a more cost-effective filler than a polymer filler.

Adhesive sheet 14 is applied to foil laminate layer 12, 112, 212 and is configured to adhere substantially to three-ply laminated sheet 12, 112, 212 when release liner 16 is removed or otherwise separated from adhesive sheet 14. In illustrative embodiments, adhesive sheet 14 is an acrylic pressure-sensitive adhesive suitable for use in cold temperatures. In another illustrative embodiment, adhesive sheet 14 may also be a hot melt SIS, a natural rubber, a rubber blend, or a silicone pressure-sensitive adhesive.

Adhesive sheet 314 is applied to three-ply laminated sheet 12 as suggested in FIG. 4. Adhesive sheet 314 in illustrative embodiments is a heat-activated adhesive, but in other illustrative embodiments may be a water-activated adhesive.

Release liner 16 is coupled to adhesive sheet 14 and configured so that it may be removed by a user (not shown) prior to application of foil laminate adhesive tape 10, 100, 200 to an article. In illustrative embodiments, release liner 16 comprises a release substrate (not shown) and a silicone coating (not shown), but may be any suitable alternative. The silicone coating is arranged to lie between the release substrate and adhesive sheet 14 facilitating removal of release substrate.

Illustratively, adhesive tape 10, 100, 200, 300 is adapted for use with heating, ventilation, and air conditioning (HVAC) systems and is configured to mate with articles 11 included in such systems. In illustrative embodiments, adhesive tape in accordance with the present disclosure is suited for non-UL and UL 181A-P and UL 181B-FX applications. After manufacture, adhesive tape 10, 100, 200,300 may be wound to form a roll (not shown) so as to facilitate storage, shipment, and application.

1. A pressure-sensitive adhesive tape comprising
a laminated sheet,
a release liner, and
an adhesive sheet interposed between the laminated sheet and the release liner, wherein the laminated sheet includes a first foil layer made of a thin piece of aluminum material, a second foil layer made of another thin piece of aluminum material, and a substrate layer interposed between and mated with the first and second foil layers and made of a non-aluminum material.

2. The tape of claim 1, wherein the substrate layer has a thickness of about 0.7 mil to about 2.2 mil to provide the laminated sheet with a thickness of about 1.5 mil to about 6.0 mil.

3. The tape of claim 1, wherein the first foil layer includes an exterior surface facing away from the substrate layer and an interior surface mating with a first side of the substrate layer and the second foil layer includes an exterior surface facing away from the substrate layer and in interior surface mating with a second side of the substrate layer and lying in spaced-apart relation to the interior surface of the first foil layer to cause the substrate layer to lie between the interior surface of the first and second foil layers.

4. The tape of claim 1, wherein the substrate layer is a single binder stratum made of a polymeric material.

5. The tape of claim 4, wherein the first foil layer has a thickness of about 0.5 mil, the second foil layer has a thickness of about 0.3 mil, and the single binder stratum has a thickness of about 0.7 mil to about 2.2 mil to provide the laminated sheet with a thickness of about 1.5 mil to about 3.0 mil.

6. The tape of claim 4, wherein the single binder stratum has a thickness of about 0.7 mil to about 2.2 mil to provide the laminated sheet with a thickness of about 1.5 mil to about 3.0 mil.

7. The tape of claim 4, wherein the single binder stratum is made of low-density polyethylene and has a thickness of about 1.0 mil to provide the laminated sheet with a thickness of about 1.8 mil.

8. The tape of claim 1, wherein the substrate layer comprises a first binder stratum mated to the first foil layer, a second binder stratum mated to the second foil layer, and a core stratum interposed between and mated with the first and second binder stratums.

9. The tape of claim 8, wherein the core stratum is made of a non-woven polymeric material.

10. The tape of claim 8, wherein the core stratum is made of one of a polyester and a polypropylene material and each of the first and second binder stratums is made of one of a polyethylene and a polypropylene material.

11. The tape of claim 8, wherein the core stratum is made of a paper material.

12. The tape of claim 8, wherein the core stratum is made of a non-polymeric material.

13. The tape of claim 8, wherein the core stratum is made of a virgin twenty-point paper and each of the first and second binder stratums is made of one of a polyethylene and a polypropylene material.

14. The tape of claim 8, wherein the substrate layer has a thickness of about 0.7 mil to about 2.2 mil to provide the laminated sheet with a thickness of about 1.5 mil to about 6.0 mil.

15. A pressure-sensitive adhesive tape comprising
an adhesive sheet and
a laminated sheet coupled to the adhesive sheet, wherein the laminated sheet includes a first foil layer made of a thin piece of aluminum material, a second foil layer made of another thin piece of aluminum material, and a substrate layer interposed between and mated with the first and second foil layers and made of a non-aluminum material.

16. The tape of claim 15, wherein the substrate layer has a thickness of about 0.7 mil to about 2.2 mil to provide the laminated sheet with a thickness of about 1.5 mil to about 6.0 mil.

17. The tape of claim 16, wherein the substrate layer is a single binder stratum made of a polymeric material.

18. The tape of claim 16, wherein the substrate layer comprises a first binder stratum mated to the first foil layer, a second binder stratum mated to the second foil layer, and a core stratum interposed between and mated with the first and second binder stratums.

19. A pressure-sensitive adhesive tape comprising an adhesive sheet coupled to a three-ply laminated sheet comprising a non-foil substrate layer interposed between and coupled to first and second foil layers.

20. The tape of claim 19, wherein the substrate layer comprises a first binder stratum mated to the first foil layer, a second binder stratum mated to the second foil layer, and a core stratum interposed between and mated with the first and second binder stratums.
